(19) United States
(12) Patent Application Publication
(10) Pub. No.: US 2010/0106928 A1
(43) Pub. Date: Apr. 29, 2010

(54) STORAGE DEVICE, STORAGE SYSTEM, AND UNLOCK PROCESSING METHOD

(75) Inventors: Seiji Toda, Kawasaki (JP); Teruji Yamakawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/555,209

(22) Filed: Sep. 8, 2009

(30) Foreign Application Priority Data
Oct. 29, 2008 (JP) 2008-278707

(51) Int. Cl. G06F 12/14; G06F 12/00

(52) U.S. Cl. 711/163; 711/E12.001; 711/E12.093

(57) ABSTRACT

According to one embodiment, a storage device manages a user data area by dividing the area into a plurality of division data areas. The storage device includes a storage module, an access authority setting module, a lock processor, a command receiver, and an unlock processor. The storage module includes the division data areas. The access authority setting module sets access authority with respect to each division data area for each user. The lock processor disables access to the storage module from a host device that reads data from and writes data to the storage module. The command receiver receives from the host device an unlock command including a basic area storing basic unlock information and an expansion area storing additional unlock information. The unlock processor unlocks each division data area, to which access is restricted for each user, based on the basic unlock information and the additional unlock information.

### CROSS-REFERENCE TO RELATED APPLICATIONS

This application is based upon and claims the benefit of priority from Japanese Patent Application No. 2008-278707, filed Oct. 29, 2008, the entire contents of which are incorporated herein by reference.

### BACKGROUND

1. Field

One embodiment of the invention relates to a storage device, a storage system, and an unlock processing method.

2. Description of the Related Art

In general, a storage device, such as a hard disk drive (HDD), is provided with a data management function to lock read/write operation on user data. For example, in a storage device provided with an advanced technology attachment (ATA) interface, the data management function is realized by a command group based on the Security Feature Set.

However, with the conventional data management function, a sophisticated data management, such as to divide a user data area into a plurality of areas to manage the user data area or to restrict execution of lock/unlock process by a plurality of user authorities, cannot be performed, which limits the use.

In recent years, a new interface has been proposed to provide the storage device with the sophisticated data management function. As an example, a protocol that is defined by a storage working group (SWG) of a trusted computing group (TCG) is known. If this protocol is provided to the storage device, a sophisticated security management can be achieved, in which a user data area is managed by dividing it into a plurality of division data areas, by a plurality of user authorities, or the like. Reference may be had to, for example, “TCG Storage Architecture Core Specification Version 1.0 Revision 0.9”, [online], [search on Sep. 22, 2008], Internet URL:https://www.trustedcomputinggroup.org/specs/Storage/TCG_S torage_Architecture_Core_Specification_v01.9.pdf.

However, when the storage device with the sophisticated data management function is connected to a host device, such as a personal computer (PC), the host device needs to have an additional new function. In particular, although the change of the BIOS is required to wake up the storage device from standby, it is difficult to change the BIOS.

Specifically, the host device has standby mode in which power supply to the storage device or other devices is OFF to suppress power consumption. In addition, when the host device enters the standby mode, the storage device is locked so that read/write operation by the host device is disabled. On the other hand, when the host device wakes up from the standby mode, the host device issues an unlock command to unlock the storage device. At this time, since the above process is performed before an operation system (OS) of the host device wakes up, the unlock command is issued by the BIOS.

As described above, to unlock the multifunctional storage device, the BIOS needs to be changed. However, differently from a host application, the BIOS has a high edition revision cost and cannot be easily changed. Further, since the storage area of the BIOS is limited, it is difficult to provide a sophisticated protocol as defined by the TCG.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a storage system according to an embodiment of the invention;

FIG. 2 is an exemplary diagram of a user data lock management table in the embodiment;

FIG. 3 is an exemplary diagram of a configuration of an unlock command in the embodiment;

FIG. 4 is an exemplary diagram of a configuration of return information to a device identification command in the embodiment;

FIG. 5 is an exemplary flowchart of an unlock process by a BIOS of a host device in the embodiment;

FIG. 6 is an exemplary flowchart of an unlock process by a storage device in the embodiment; and

FIG. 7 is an exemplary flowchart of an expansion command operation executing process of the storage device in the embodiment.

### DETAILED DESCRIPTION

Various embodiments according to the invention will be described hereinafter with reference to the accompanying drawings. In general, according to one embodiment of the invention, a storage device is configured to manage a user data area by dividing the user data area into a plurality of division data areas. The storage device comprises a storage module, an access authority setting module, a lock processor, a command receiver, and an unlock processor. The storage module includes the division data areas. The access authority setting module is configured to set access authority with respect to each of the division data areas for each of a plurality of users. The lock processor is configured to access the storage module and disable access to the storage module from a host device configured to read data from and write data to the storage module. The command receiver is configured to receive an unlock command issued by the host device. The unlock command includes a basic area and an expansion area. The unlock processor is configured to unlock each of the division data areas to which access is restricted for each of the users based on basic unlock information stored in the basic area and additional unlock information stored in the expansion area.

According to another embodiment of the invention, a storage system comprises a storage device and a host device configured to be connected to the storage device. The host device comprises an access processor and a command issuing module. The access processor is configured to access a storage module of the storage device to read data from and write data to the storage module. The command issuing module is configured to issue an unlock command to the storage device. The unlock command includes a basic area that stores basic unlock information and an expansion area that stores additional unlock information.

The storage device comprises the storage module, an access authority setting module, a lock processor, a command receiver, and an unlock processor. The storage module is configured to manage a user data area by dividing the user data area into a plurality of division data areas. The access authority setting module is configured to set access authority with respect to each of the division data areas for each of a plurality of users. The lock processor configured to access the storage module and disable access from the host device to the storage module. The command receiver is configured to receive the unlock command issued by the host device. The unlock processor is configured to unlock each of the division data areas to which access is restricted for each of the users based on the basic unlock information and the additional unlock information.

According to still another embodiment of the invention, there is provided an unlock processing method applied to a storage system comprising a storage device and a host device configured to be connected to the storage device. The unlock processing method comprises: the storage device disabling access from the host device to a storage module of the host device; the host device issuing an unlock command to the storage device, the unlock command including a basic area that stores basic unlock information and an expansion area that stores additional unlock information; the storage device receiving the unlock command issued by the host device; and the storage device unlocking each of division data areas where access authority is set for each user based on the basic unlock information and the additional unlock information.

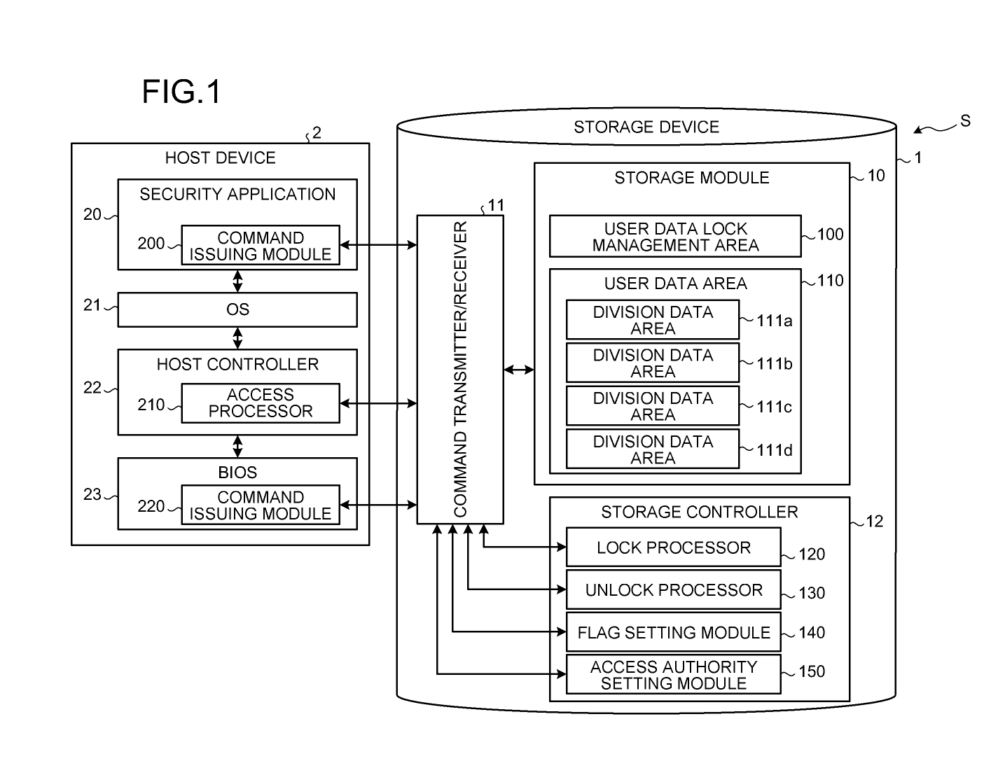

A description will now be given of a configuration of a storage device according to an embodiment of the invention. FIG. 1 is a block diagram of a storage system S according to the embodiment. As illustrated in FIG. 1, the storage system S comprises a storage device 1 and a host device 2.

The storage device 1 comprises a storage module 10, a command transmitter/receiver 11, and a storage controller 12. The storage module 10 stores various data. The storage module 10 is provided with a user data lock management area 100 and a user data area 110. The user data area 110 stores various data used by the user, such as image data or text data. The user data area 110 is divided into division data areas 111a to 111d. In the following, among the division data areas 111a to 111d, arbitrary one of them is refereed to as “division data area 111”.

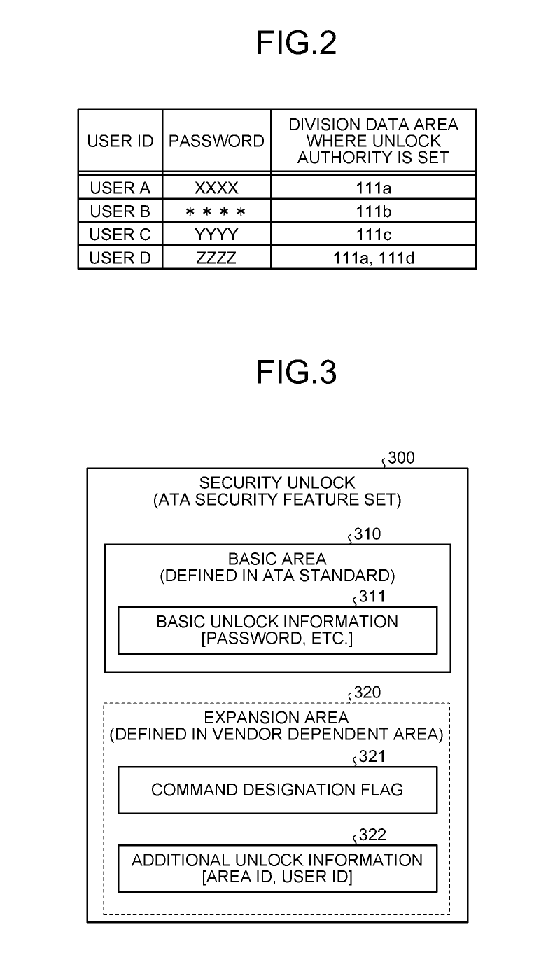

The user data lock management area 100 manages, for every user, information necessary to unlock the storage device 1. The user data lock management area 100 includes a user data lock management table. As illustrated in FIG. 2, the user data lock management table stores user ID, password, and area ID of division data area where unlock authority is set in association with one another. In the example of FIG. 2, a user ID “user A” is associated with a password “XXXX”. Further, user A has unlock authority with respect to the division data area 111a, and thus is capable of unlocking the division data area 111a.

The command transmitter/receiver 11 functions as a command receiver, and receives an unlock command issued by the host device 2 or transmits various types of information to the host device 2.

The storage controller 12 controls the overall operation of the storage device 1. The storage controller 12 comprises a lock processor 120, an unlock processor 130, a flag setting module 140, and an access authority setting module 150. The lock processor 120 disables access to the storage module 10 of the host device 2. For example, when the host device 2 enters standby mode, the lock processor 120 locks the storage module 10 so that the host device 2 is disabled to perform read/write operation with respect to the division data area 111.

As described above, the storage device 1 of the embodiment has a data management function to manage a user data area by dividing the user data area into a plurality of division data areas, and sets access authority with respect to each of the division data areas for each of users. Such a data management function is realized based on a protocol defined by SWG of TCG implemented on a TRUSTED SEND/RECEIVE command of an ATA interface. The storage device 1 operates based on the protocol defined by SWG of TCG (hereinafter, “TCG protocol”). Apart from the TCG protocol, the storage device 1 is provided with a command group based on the Security Feature Set of ATA interface.

The unlock processor 130 unlocks each of the locked division data areas to which access is restricted for each user based on basic unlock information and additional unlock information stored in a basic area and an expansion area of the unlock command received by the command transmitter/receiver 11, respectively. Next, a configuration of the unlock command issued by the host device 2 will be described with reference to FIG. 3. FIG. 3 illustrates an example of the configuration of the unlock command in the embodiment.

An unlock command 300 is a command based on the Security Feature Set of the ATA interface, and includes a basic area 310 and an expansion area 320 as illustrated in FIG. 3. The basic area 310 is an area defined in the standard of the ATA interface, and stores basic unlock information 311. The basic unlock information 311 may be, for example, a password.

Further, the expansion area 320 is an area defined in a vendor specific area of the unlock command 300, and stores a command designation flag 321 and additional unlock information 322.

The command designation flag 321 is identification information to identify whether to perform data management using the TCG protocol (i.e., whether to manage a user data area by dividing the user data area into a plurality of division data areas, and set access authority with respect to each of the division data areas for each of users). In the embodiment, when “0” is set to the command designation flag 321, the data management function using the TCG protocol is not used. On the other hand, when “1” is set to the command designation flag 321, the data management function using the TCG protocol is used. The unlock processor 130 performs an unlock process based on the command designation flag 321.

The additional unlock information 322 may be, for example, area ID assigned to each division data area 111 and user ID unique to each user.

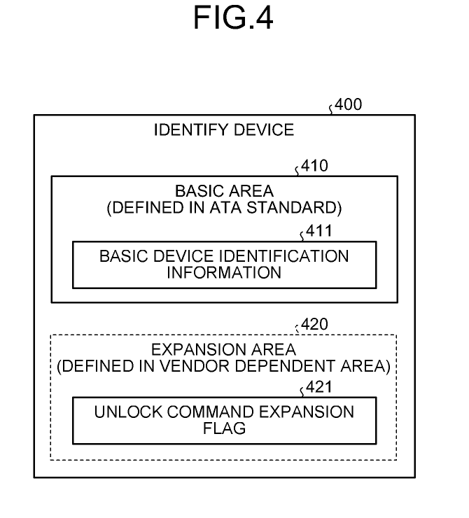

The flag setting module 140 sets an unlock command expansion flag as one of return information with respect to a device identification command received from the host device 2. The device identification command is a command that is generally provided to an ATA device and notifies the host device 2 of detailed information of the storage device 1. Next, a configuration of the return information to the device identification command will be described with reference to FIG. 4. FIG. 4 illustrates an example of the configuration of the return information to the device identification command in the embodiment.

As illustrated in FIG. 4, return information 400 includes a basic area 410 and an expansion area 420. The basic area 410 is an area defined in the standard of the ATA interface, and stores basic device identification information 411. Examples of the basic device identification information 411 include capacity, name, and version information of the storage device 1.

The expansion area 420 is an area defined in a vendor specific area, and stores an unlock command expansion flag 421. The unlock command expansion flag 421 is a flag indicating whether the storage device 1 corresponds to the data management function using the TCG protocol. In the embodiment, when “0” is set to the unlock command expansion flag 421, the storage device 1 does not correspond to the data management function using the TCG protocol. On the other hand, when “1” is set to the unlock command expansion flag 421, the storage device 1 corresponds to the data management function using the TCG protocol. The unlock command expansion flag 421 is set by the flag setting module 140.

The access authority setting module 150 sets access authority with respect to the division data area 111 for each of users. The access authority setting module 150 updates contents of the user data lock management table according to an instruction from the host device 2. For example, the access authority setting module 150 registers new user information or changes a division data area with a password or access authority corresponding to a user ID.

The host device 2 comprises a security application 20, an OS 21, a host controller 22, and a BIOS 23. The security application 20 is an application for realizing the data management function using the TCG protocol, and includes a command issuing module 200. The command issuing module 200 issues a command necessary for data management based on the TCG protocol.

The OS 21 is basic software to operate the entire host device 2 and is loaded by the BIOS 23. The OS 21 comprises drivers to control various devices or various types of utility software.

The host controller 22 controls the entire host device 2. The host controller 22 includes an access processor 210. The access processor 210 accesses the storage module 10 of the storage device 1, and read data from/write data to the storage module 10.

The BIOS 23 is software incorporated in the host device 2 as firmware, and first operates when the host device 2 starts. The BIOS 23 includes a command issuing module 220. The command issuing module 220 issues the unlock command 300, in which the basic unlock information 311 is stored in the basic area 310 and the additional unlock information 322 is stored in the expansion area 320, to the storage device 1. The BIOS 23 is provided with the command group defined by the ATA interface is mounted, but not with a function for realizing the TCG protocol.

Incidentally, command expansion of the host device 2 and that of the storage device 1 need to match each other, and a protocol needs to be created between a vendor at the side of the host device 2 and a vendor at the side of the storage device 1 when a product is developed.

The user specifies various security settings based on the TCG protocol by the security application 20 of the host device 2. As one of the settings, lock management is set with respect to each area. For example, the user sets a range of logical block addresses (LBA) defined as an area and a user whose authority enables an unlock operation. The host device 2 issues the command based on the TCG protocol to the storage device 1 through the security application 20. However, when the OS 21 starts, an authentication application before starting the OS 21 defined in the specification of the TCG may be used. The authentication application is stored in a specific area of the storage device 1.

While the OS 21 is in operation, the host device 2 executes the security application 20 to realize the data management function based on the TCG protocol, and locks/unlocks the storage device 1 using the command group defined in the TCG protocol. Meanwhile, when the host device 2 is in standby mode, the OS 21 is not in operation. Therefore, the command issuing module 220 of the BIOS 23 issues the unlock command 300 for unlocking the storage device 1.

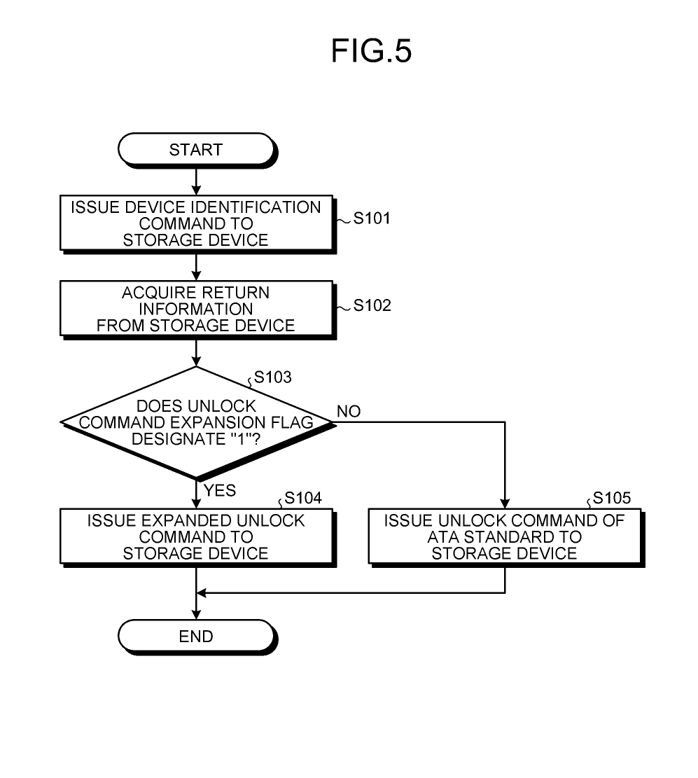

Next, the specific operation of the BIOS 23 of the host device 2 and the storage device 1 of the embodiment will be described. First, the specific operation of the BIOS 23 of the host device 2 will be described with reference to FIG. 5. FIG. 5 is a flowchart of an unlock process by the BIOS 23 of the host device 2 of the embodiment. In FIG. 5, of the processes performed by the BIOS 23, only the process related to the unlock process of the storage device 1 is illustrated.

As illustrated in FIG. 5, upon start of the unlock process, the command issuing module 220 of the BIOS 23 issues a device identification command to the storage device 1 (S101). Next, having received the return information 400 to the device identification command from the storage device 1 (S102), the BIOS 23 determines whether the unlock command expansion flag 421 designates “1” (S103). When it is determined that the unlock command expansion flag 421 designates “1” (Yes at S103), the command issuing module 220 issues the unlock command 300 (expanded unlock command), in which the basic unlock information 311 is stored in the basic area 310 and the additional unlock information 322 is stored in the expansion area 320, to the storage device 1 (S104).

The command issuing module 220 acquires password information as the basic unlock information 311 and a user ID and an area ID as the additional unlock information 322 based on information input from the user. Specifically, when the host device 2 wakes up from the standby mode, the user inputs his/her user ID, a password, and an area ID of the division data area 111 that the user desires to unlock using an input device (not illustrated) of the host device 2 such as a keyboard. In addition, the command issuing module 220 generates the unlock command 300 based on the information input from the user, and transmits the unlock command to the storage device 1.

Meanwhile, when it is determined that the unlock command expansion flag 421 does not designate “1” (No at S103) the command issuing module 220 issues an unlock command (unlock command where the additional unlock information 322 is not stored) of the ATA standard to the storage device 1 (S105). After the process at S104 or S105, the BIOS 23 completes the unlock process.

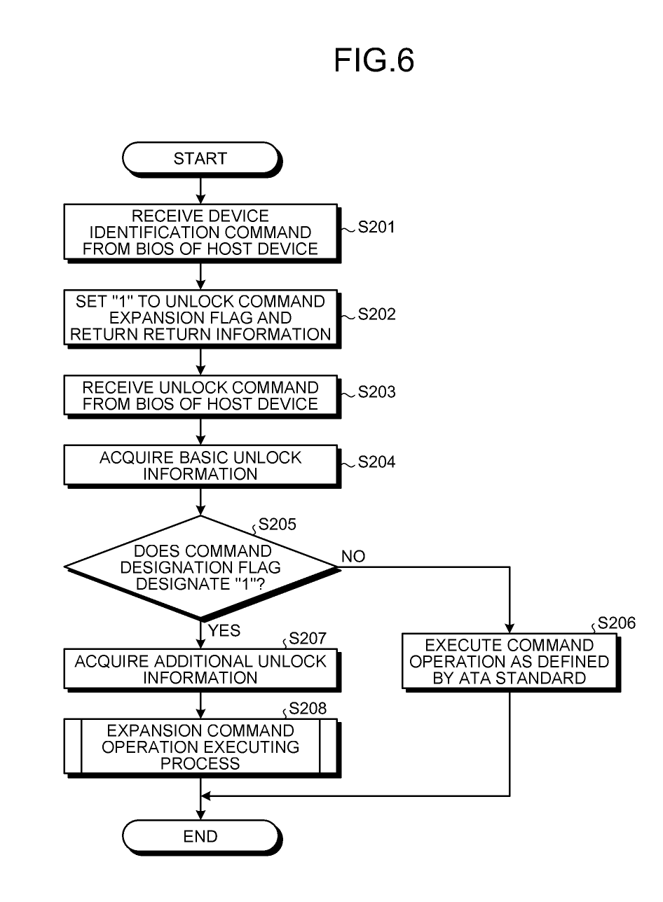

Next, the specific operation of the storage device 1 will be described with reference to FIG. 6. FIG. 6 is a flowchart of an unlock process by the storage device according to the embodiment. In FIG. 6, of the processes performed by the storage device 1, only the process related to the unlock process is illustrated.

As illustrated in FIG. 6, upon start of the unlock process, the storage controller 12 receives the device identification command from the BIOS 23 of the host device 2 through the command transmitter/receiver 11 (S201). Next, the flag setting module 140 sets “1” to the unlock command expansion flag 421, and returns the return information 400 through the command transmitter/receiver 11 (S202).

Next, having received the unlock command 300 from the BIOS 23 of the host device 2 (S203), the storage controller 12 acquires the basic unlock information 311 stored in the basic area 310 of the unlock command 300 (S204). Next, the storage controller 12 determines whether the command designation flag 321 stored in the expansion area 320 of the unlock command 300 designates “1” (S205). When it is determined that the command designation flag 321 does not designate “1” (No at S205), the unlock processor 130 perform command operation as defined in the ATA standard (S206).

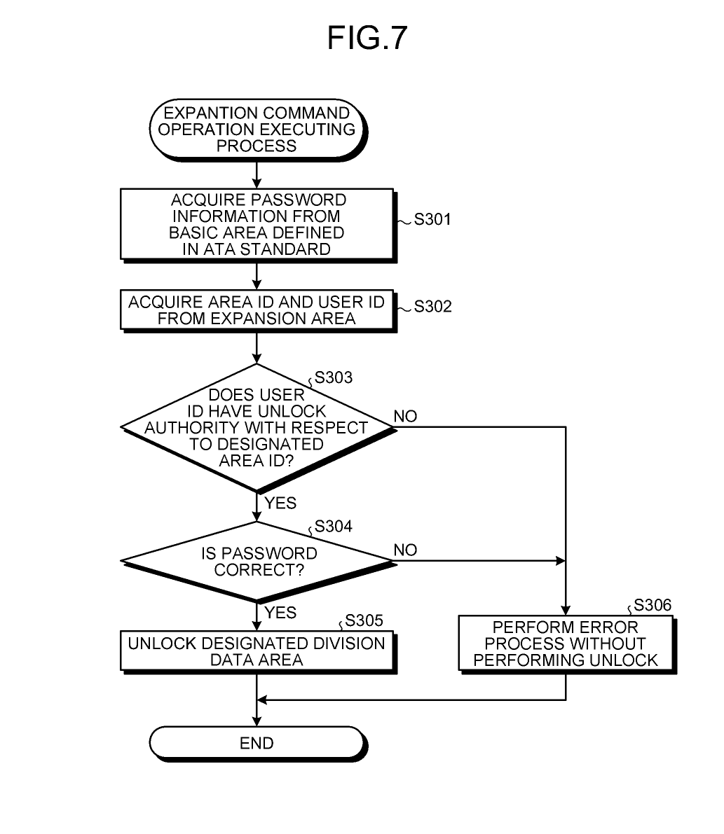

Meanwhile, when it is determined that the command designation flag 321 designates “1” (Yes at S205), the unlock processor 130 acquires the additional unlock information 322 stored in the expansion area 320 (S207). Thus, an expansion command operation executing process is performed based on the basic unlock information 311 acquired at S204 and the additional unlock information 322 acquired at S207 (S208). The expansion command operation executing process corresponds to the process from S301 to S306 in FIG. 7, which will be described in detail below. After the process at S206 or S208, the storage control module 12 completes the unlock process.

As described above, the unlock processor 130 of the embodiment determines whether to perform the unlock process according to the data management function using the TCG protocol or the unlock process of the ATA standard based on the command designation flag 321. Accordingly, the storage device 1 performs conventional unlock process with respect to the host device not provided with the TCG protocol. Meanwhile, the storage device 1 can perform the unlock process based on the TCG protocol with respect to the host device 2 provided with the TCG protocol. That is, the storage device 1 of the embodiment can maintain compatibility with respect to both the host device 2 provided with the TCG protocol and the host device not provided with the TCG protocol.

Next, the expansion command operation executing process at S208 in FIG. 6 will be described with reference to FIG. 7. FIG. 7 is a flowchart of the expansion command operation executing process performed by the storage device 1 of the embodiment.

As illustrated in FIG. 7, upon start of the expansion command operation executing process, the unlock processor 130 acquires password information as the basic unlock information 311 from the basic area 310, i.e., the area defined in the ATA standard (S301). Next, the unlock processor 130 acquires an area ID and a user ID as the additional unlock information 322 from the expansion area 320 (S302).

Next, the unlock processor 130 determines whether the user ID acquired at S302 has unlock authority with respect to the designated area ID (area ID acquired at S302) (S303). The unlock processor 130 makes this determination referring to the user data lock management table. When it is determined that the user ID acquired at S302 has unlock authority with respect to the designated area ID (Yes at S303), the process proceeds to S304. Specifically, when the user ID acquired at S302 is “userA”, or when the designated area ID is “111a”, the process proceeds to S304.

The unlock processor 130 determines whether the password acquired at S301 is correct. The unlock processor 130 makes this determination referring to the user data lock management table. When it is determined that the password acquired at S301 is correct (Yes at S304), the unlock processor 130 unlocks the division data area 111 corresponding to the designated area ID (S305).

On the other hand, when it is determined that the user ID acquired at S302 does not have unlock authority with respect to the designated area ID (No at S303), or when it is determined that the password acquired at S301 is incorrect (No at S304), the unlock processor 130 performs an error process without performing the unlock process (S306). The error process may be, for example, the process of transmitting an error message to the host device 2. After the process at S305 or S306, the unlock processor 130 completes the expansion command operation executing process.

Incidentally, with the TCG protocol, settings may be specified such that the division data area 111 is unlocked by a plurality of passwords, not a single password. To cope with this, at the side of the storage device 1, it may be previously specified that the settings cannot be changed, or, if such settings have been specified, the above unlock process may be disabled.

As described above, according to the embodiment, sophisticated unlock process based on the TCG protocol can be realized between the storage device 1 and the host device 2 without the significant change of the BIOS 23 with high edition revision cost and limited storage area.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device configured to manage a user data area by dividing the user data area into a plurality of division data areas, the storage device comprising:
a storage module including the division data areas;
an access authority setting module configured to set access authority with respect to each of the division data areas for each of a plurality of users;
a lock processor configured to access the storage module and disable access from a host device to the storage module, the host device configured to read data from and write data to the storage module;
a command receiver configured to receive an unlock command issued by the host device, the unlock command including a basic area and an expansion area; and
an unlock processor configured to unlock each of the division data areas to which access is restricted for each of the users based on basic unlock information stored in the basic area and additional unlock information stored in the expansion area.

2. The storage device according to claim 1, wherein
the additional unlock information includes identification information that identifies whether to use a data management function for managing the user data area by dividing the user data area into the division data areas and setting the access authority with respect to each of the division data areas for each of the users,
when the identification information indicates that the data management function is not to be used, the unlock processor unlocks each of the division data areas based on the basic unlock information stored in the basic area, and
when the identification information indicates that the data management function is to be used, the unlock processor unlocks each of the division data areas where the access authority is set for each of the users based on the basic unlock information stored in the basic area and the additional unlock information stored in the expansion area.

3. The storage device according to claim 2, wherein
the unlock command is based on a Security Feature Set command of an advanced technology attachment (ATA) interface, and
the data management function is realized based on a protocol defined by a storage working group of a trusted computing group implemented on a TRUSTED SEND/RECEIVE command of the ATA interface.

4. A storage system comprising:
a storage device; and
a host device configured to be connected to the storage device, wherein
the host device comprises
an access processor configured to access a storage module of the storage device to read data from and write data to the storage module, and
a command issuing module configured to issue an unlock command to the storage device, the unlock command including a basic area that stores basic unlock information and an expansion area that stores additional unlock information, and
the storage device comprises
the storage module configured to manage a user data area by dividing the user data area into a plurality of division data areas,
an access authority setting module configured to set access authority with respect to each of the division data areas for each of a plurality of users,
a lock processor configured to access the storage module and disable access from the host device to the storage module,
a command receiver configured to receive the unlock command issued by the host device, and
an unlock processor configured to unlock each of the division data areas to which access is restricted for each of the users based on the basic unlock information and the additional unlock information.

5. The storage system according to claim 4, wherein
the additional unlock information includes identification information that identifies whether to use a data management function for managing the user data area by dividing the user data area into the division data areas and setting the access authority with respect to each of the division data areas for each of the users,
when the identification information indicates that the data management function is not to be used, the unlock processor unlocks each of the division data areas based on the basic unlock information stored in the basic area, and
when the identification information indicates that the data management function is to be used, the unlock processor unlocks each of the division data areas where the access authority is set for each of the users based on the basic unlock information stored in the basic area and the additional unlock information stored in the expansion area.

6. The storage system according to claim 5, wherein
the unlock command is based on a Security Feature Set command of an advanced technology attachment (ATA) interface, and
the data management function is realized based on a protocol defined by a storage working group of a trusted computing group implemented on a TRUSTED SEND/RECEIVE command of the ATA interface.

7. An unlock processing method applied to a storage system comprising a storage device and a host device configured to be connected to the storage device, the unlock processing method comprising:
the storage device disabling access from the host device to a storage module of the host device;
the host device issuing an unlock command to the storage device, the unlock command including a basic area that stores basic unlock information and an expansion area that stores additional unlock information;
the storage device receiving the unlock command issued by the host device; and
the storage device unlocking each of division data areas where access authority is set for each user based on the basic unlock information and the additional unlock information.

8. The unlock processing method according to claim 7, wherein
the additional unlock information includes identification information that identifies whether to use a data management function for managing the user data area by dividing the user data area into the division data areas and setting the access authority with respect to each of the division data areas for each of the users,
when the identification information indicates that the data management function is not to be used, the storage device unlocks each of the division data areas based on the basic unlock information stored in the basic area, and
when the identification information indicates that the data management function is to be used, the storage device unlocks each of the division data areas where the access authority is set for each of the users based on the basic unlock information stored in the basic area and the additional unlock information stored in the expansion area.

9. The unlock processing method according to claim 8, wherein
the unlock command is based on a Security Feature Set command of an advanced technology attachment (ATA) interface, and
the data management function is realized based on a protocol defined by a storage working group of a trusted computing group implemented on a TRUSTED SEND/RECEIVE command of the ATA interface.
